(19) United States
(12) Patent Application Publication
(10) Pub. No.: US 2014/0225922 A1
(43) Pub. Date: Aug. 14, 2014

(54) SYSTEM AND METHOD FOR AN AUGMENTED REALITY SOFTWARE APPLICATION

(71) Applicant: Rocco A. Sbardella, Westbrook, ME (US)

(72) Inventor: Rocco A. Sbardella, Westbrook, ME (US)

(21) Appl. No.: 14/176,512

(22) Filed: Feb. 10, 2014

Related U.S. Application Data
(60) Provisional application No. 61/763,383, filed on Feb. 11, 2013.

(51) Int. Cl. G06T 19/00

(52) U.S. Cl. CPC G06T 19/006
USPC 345/633

(57) ABSTRACT

The present invention relates to an augmented reality software application apparatus and method that modifies an art object to include attachment points to shape, scale, align, and orient the art object to integrate it within a real-world environment image. Through the integration, the interior of a building showing each room and its contents from an outside elevational view similar to a dollhouse may be displayed on a mobile device within a proximity of the real-world location of the building. Using these structural attachment points the present invention may further warp and transform the augmented reality display.

### FIELD OF THE INVENTION

The present invention is an augmented reality software application system apparatus and method that with the aid of a smartphone or mobile computer system allows a User to create a User generated collection of Art Objects that have been linked to Real-World Environment Live Images. These Art Objects may include the ability to view from the outside of a building the interior contents or other information about the building or any other information that is associated with a geographic location. An augmented reality view of a geographic location is developed through three dimensional scaling, alignment, virtual attachment and integration of the Art Object with a Real-World Environment Image. For example, the geographic location may be automatically transmitted to a device based on the GPS location of the device and an Art Object showing the interior contents may be merged with an external image of a building at the geographic location thereby creating a virtual dollhouse of the building. The present invention may further provide for a User to warp and transform the Art Objects within the augmented reality views of the geographic location using virtual attachment Anchor Points or Handles to deform or distort the augmented reality views.

### BACKGROUND OF THE INVENTION

An augmented reality software application system is described in U.S. Pat. No. 7,853,296 to Yu et al. where a message of virtual graffiti is associated with a particular physical location and may be displayed on a mobile device through the merger of the virtual graffiti and a Real-World Environment Image. The virtual graffiti may be downloaded and displayed when a device is near the physical location or the virtual graffiti may be associated with a particular object and the message is displayed when a device is in the vicinity of that object. The virtual graffiti may be filtered based on User feedback to accept or reject the display of the virtual message. The Augmented Reality Application System of Yu et al. fails to describe a User generated collection of Art Objects or an external viewing of the interior contents of a building from the outside of the building. Yu et al. also fails to disclose available virtual attachment Anchor Points and Handles that provide for a User to position, scale, orient, deform or distort the augmented reality views.

### OBJECTS AND SUMMARY OF THE INVENTION

The Augmented Reality Application Software System apparatus presents on a mobile device detailed information about a geographic location including an ability to view the interior of the building showing its contents from an outside elevational view thereby presenting a virtual dollhouse of the specified building.

An object of the invention is the creation or association of an Art Object with a Real-World Environment Virtual Image using an augmented building block creator to define handles located on the Art Object that may attach to Anchor Points located on the Real-World Environment Virtual Image the Anchor Points duplicated on a live image or video feed of a Real-World Environment Visual Image to view the Art Object on the Visual Image in real-time.

An object of the invention is the creation of an Art Object collection where an Art Object may be virtually attached to a Real-World Environment Visual Image using Anchor Points defined in a in a Real-World Environment Virtual Image.

Another object of the invention is the duplication of an Art Object into a two dimensional or three dimensional augmented building blocks (ABB) that includes a Bounding Prism and virtual attachment Handles to move and connect the Art Object to other augmented building blocks or to Real-World Environment Virtual Images and related visual displays.

Another object of the invention is interactive content associated with the User created Art Objects including but not limited to Animations, Buttons, Web Content, Surveys, Coupons, or Games.

Another object of the invention is the use of ABBs as a part of a User created Art Object to virtually attach or give the Art Object to customers via their Sponsored Art Objects' Interactive Content.

Another object of the invention is the creation of a free standing sign post that may display text in the form of a 3D Art Object developed using the Art Object Studio test editor. The User may also attach Handles to the Sign Post for the attachment of Art Objects and ABBs.

Another object of the invention is the creation of Treasure Chests as ABBs that leave things inside for other Users to find. These things may be ABBs, web links, video, coupons, gifts, or any other system components.

Another object of the invention is a building block tool that allows the User to build Art Objects out of individual ABB's.

Another object of the invention is an embedded video tool that allows a User to add live or prerecorded video streams to a sponsored Art Object.

Another object of the invention is a warp field tool that creates a bump map that overlays on top of the Real-World Environment Virtual Image taken by the User and allows a User to pull, stretch, extend, expand, contract, resize and push the surface of the image to modify, deform, distort and change the shape and appearance of the image. This modified image is transformed into an ABB for the purposes of an Art Object creation and superimposed on a related Real-World Environment Visual Image at the geographic location of the Real-World Environment Virtual Image thereby making, for example, a building at the geographic location appear on the display as warped, distorted or otherwise deformed as desired by the User.

A further object of the invention is the ranking of an Art Object and the replacement of an Art Object with an Art Object of a higher ranking by disconnecting the Handles between ABBs and/or adding higher ranking virtual Anchor Points from a Virtual Image to the Real-World Environment Visual Image.

A still further object of the invention is the ability for a User to throw certain ABBs that may then interact with other ABBs and Art Objects when a collision is detected. The outcome and resulting display on the Real-World Environment Visual Image of this collision is defined within the creation and/or ranking of the ABB being thrown.

The present invention is related to an augmented reality software system apparatus for the integration of an art object with a real-world environment image, comprising application software stored in memory of a mobile computer system, the mobile computer system having a camera, the application software comprising; an art object studio; an augmented building block creator; an art object database; and wherein a picture of an object in a real-world environment is taken and saved to memory of the computer system as a virtual target image; a digital art object is created in the art object studio and duplicated; and the art object is then transformed into an art object model using the augmented building block creator by adding a bounding prism and at least one handle located on one of at least the art object and bounding prism; the at least one handle is attached to at least one anchor point on the virtual target and the art object model and the virtual target is saved to the art object database, a live picture of a related real-world environment visual target image is taken using the camera of the mobile computer system; and using the application software the virtual target image is aligned to the visual target image using the anchor point to display the art object in real-time on the visual target. The augmented reality software system apparatus for the integration of an art object with a real-world environment image is further related to the visual target being a live video. In the augmented reality software system apparatus, the placement and adjustment of the handles modifies one of at least the shape, scale and orientation of the art object model. The augmented reality software system apparatus for the integration of an art object with a real-world environment image further comprises a plurality of augmented building blocks each having the same art object and each having handles at different locations on a feature of the art object or the bounding prism; and the augmented building blocks are stackable. The augmented reality software system also further comprises art modification tools that provide for warp field lines to be drawn on the virtual target, anchor points, positioned along the warp field lines on the virtual target can manipulate objects within the virtual target to perform one of at least a modification, a deformation, a distortion, and change of shape of the virtual target in real time when integrated with the visual target.

The augmented reality software system apparatus further comprises a device locator that records the geographic location around at least one visual target with the device locator presetting a radius around the geographic location and providing notifications of available art objects stored within one of at least the user art object database; a client art object database; a commercial entity database, a sponsored art object database, and the available art objects being accepted by a user for integration with real-world environment visual targets within the geographic location. The available arts objects are displayed on the visual target based on a ranking. The visual target of the augmented reality software system apparatus may be a building and the art object model is an interior display of a room within the building creating a virtual dollhouse using the handles of the augmented building block and anchor points on the virtual target to align the interior room art object model within the walls of the building as displayed on the visual target. The art object may be an animated image, a video, an operable button, web content, a survey, a coupon, a gift and a game.

The present invention is further related to a method for the integration of an art object with a real-world environment image using an augmented reality software system, comprising the steps of installing application software in the memory of a mobile computer system, the mobile computer system having a camera; taking a picture from a real-world environment using the camera as part of the mobile computer system; saving the picture as a virtual target; creating a digital art object; duplicating the art object; transforming the duplicated art object using an augmented building block creator into an art object model by adding a bounding prism and at least one handle on one of at least a feature of the art object and the bounding prism; attaching at least one handle of the art object model to at least one anchor point located on the virtual target; taking a live picture from a real-world environment using the camera as part of the mobile computer system; recording geographic and physical sensor data related to the real-world environment live picture to form a visual target image; aligning at least one anchor point of the virtual target with an object located on the visual target image to display an integrated live real-world image having the art object.

The method using the augmented reality software system further comprises the steps of taking a live video from a real-world environment using a camera as part of the mobile computer system; recording geographic and physical sensor data related to the real-world environment live video to form a visual target image; aligning at least one anchor point of the virtual target with an object located on the visual target image to display an integrated live real-world video having the art object. The method also further comprises the step of performing one of at least modifying the art object model using the handles to change one of at least the shape of the art object, the scaling of the art object, and the orientation of the art object. The method also further comprises the steps of creating a plurality of augmented building blocks each having the same art object and each having handles at different locations on the art object or bounding prism; and stacking the augmented building blocks. The method for the integration of an art object with a real-world environment image using the augmented reality software system, further comprises the step of drawing warp field lines on the virtual target using art modification tools of the application software and positioning anchor points along the warp field lines on the virtual target to manipulate the virtual target to perform one of at least a modification, a deformation, a distortion, a change the shape when integrating the virtual target with the visual target.

The method for the integration of an art object with a real-world environment image using the augmented reality software system further comprises the steps of recording the geographic location of at least one visual target; presetting a radius around the geographic location; and providing notifications of available art objects stored within one of at least a user art object database; a client art object database; a commercial entity database, a sponsored art object database, accepting from the selection of an available art object for display and integration with the real-world environment visual targets within the geographic location. The method of using the augmented reality software system further comprises the steps of ranking the available art objects for display and displaying the available art objects integrated with the visual target based on the ranking. The method also further comprises the steps of taking a picture of a building as the virtual target; creating an art object that is an interior display of a room within the building of the virtual target; creating a virtual dollhouse using the handles of the augmented building block of the art object model and anchor points of the virtual target to align the interior room art object model within the walls of a related visual target that is a live video of the building. The method also further comprises the steps of creating the art object as one of at least an animated image, a video, an operable button, web content, a survey, a coupon, a gift and a game.

These and other features, advantages and improvements according to this invention will be better understood by reference to the following detailed description and accompanying drawings.

### BRIEF DESCRIPTION OF THE DRAWINGS

Several embodiments of the present invention will now be described by way of example only, with reference to the accompanying drawings in which:

FIG. 1A is a first embodiment of an Art Object transformed to an augmented building block (ABB) Art Object Model having a bounding prism and handles in an embodiment of the present invention;

FIG. 1B is a first embodiment of a multiple augmented building blocks (ABBs) for an Art Object of an embodiment of the present invention;

FIG. 2 is a first embodiment of a computer platform for an embodiment of the software application system apparatus of the present invention;

FIG. 3A is a first embodiment of a Real-World Environment Visual image;

FIG. 3B is a first embodiment of an Art Object Model with a Handle attached to an Anchor Point of a Virtual Target;

FIG. 3C is a first embodiment of a Virtual Target Image with an Art Object aligned with the related Real-World Environment Visual image of FIG. 3A;

FIG. 4 is a first embodiment of a Augmented Reality Network in an embodiment of the present invention;

FIG. 5 is a first embodiment of a flowchart for creating an Art Object on a Virtual Target and displaying the Art Object on a live Visual Target in an embodiment of the present invention;

FIG. 6 is a first embodiment of attributes of an Art Object of the present invention;

FIG. 7 is a flowchart for creating a Virtual Marquee in a first embodiment of the present invention;

FIGS. 8A-8C are first embodiments of a deformed Real-World Environment Augmented Image using the Art Object Modification Tools of the present invention;

FIG. 9 is a first embodiment of a flowchart for creating a Dollhouse Effect in an embodiment of the present invention;

FIGS. 10A-10C are first embodiments of the Dollhouse Effect of the present invention; and

FIG. 11 is a first embodiment of a flowchart for locating a device and managing content delivery within the Augmented Reality Network in an embodiment of the present invention.

### DETAILED DESCRIPTION OF THE DRAWINGS

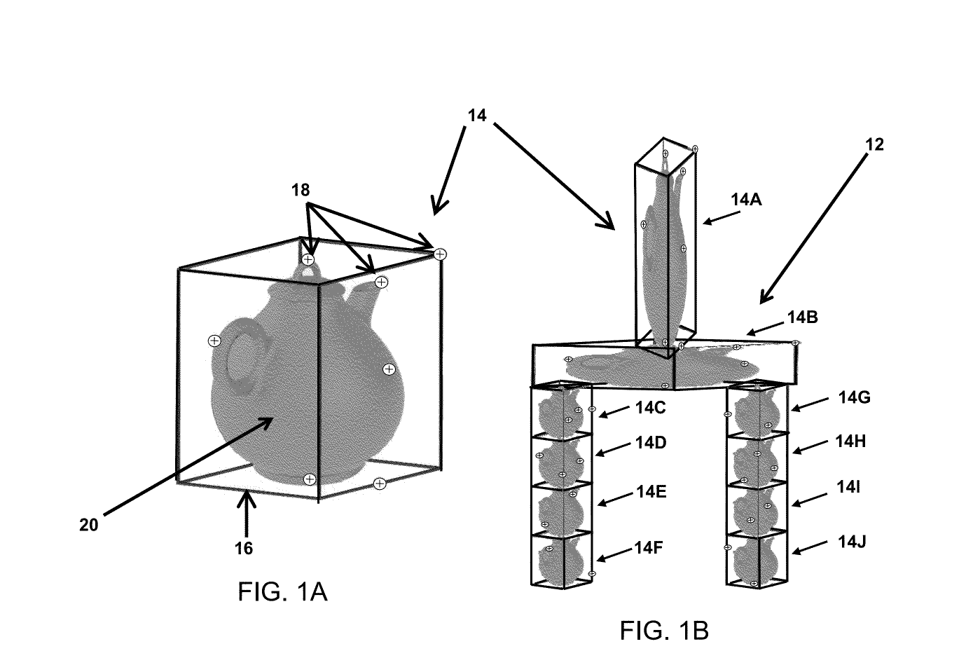

The Augmented Reality Software Application System apparatus and method provides for a User with the aid of a smartphone or mobile computer system device to create a User generated or downloaded collection of Art Objects that may be or have been linked to Real-World Environment Virtual Images. These Art Objects 12 are duplicated and transformed into Augmented Building Blocks (ABB) 14. Augmented Building Blocks (ABB) are two-dimensional (2D) or three-dimensional (3D) components of an Art Object 12 that consist of the Model/graphics, the Bounding Prism 16, and Handles 18 or virtual attachment points forming an Art Object Model 20 as shown in FIG. 1A. The Art Object Model 20 is a two or three dimensional digital representation of the Art Object 12. The Model 20 is surrounded by the Bounding Prism 16 in the form of a rectangular block positioned at each three dimensional cubic extension of the Model 20 at a specific orientation. The Handles 18 are virtual attachment points that are attached either to the Model 20 or Bounding Prism 16 that allow the User to connect the Art Object Model 20 or ABB 14 to other ABBs and to Anchor Points that are positioned on objects within a Real-World Environment Virtual Image 46. In this way an ABB of the Art Object may be associated with a Real-World Environment Virtual Image 46 that is situated at a specific geographical location. In this manner an Art Object 12 may have a single ABB 14 with a specific shape, scale and orientation based on the position of the Art Object 12 within a Real-World Environment Virtual Image 46 through the attachment of handles 18 of the Art Object 12 to Anchor Points 88 on the Virtual Image 46.

The Handles 18 of the Art Object being located on the surface features and contours of the Art Object 12 for proper placement and orientation of the Art Object within the Virtual Image 46. The Art Object 12 may further have multiple ABBs indicated as 14A-14J in FIG. 1B with each ABB 14 including the same Model/graphics, but each having a different shape, scale, orientation, distortion, modification, or other feature based on the position of the Handles 18 and modifications made to the Art Object 12 by the User. An ABB library for an Art Object 12 is stored in a User's Art Object Database 45 provided for the User to quickly select an appropriate Art Object Model 20 to properly attach the Art Object Model 20 using a Handle 18 to an Anchor Point 88 of a Virtual Target Image 46. Multiple ABBs 14 of a single Art Object or of various Art Objects are stackable by means of the Handles 18 to attach multiple Art Object Models 20 to the Anchor Points 88 of a Virtual Target 46 and display the Art Object 12 together on a related live Visual Target 48 or sequentially on a live video feed of the Visual Target 48.

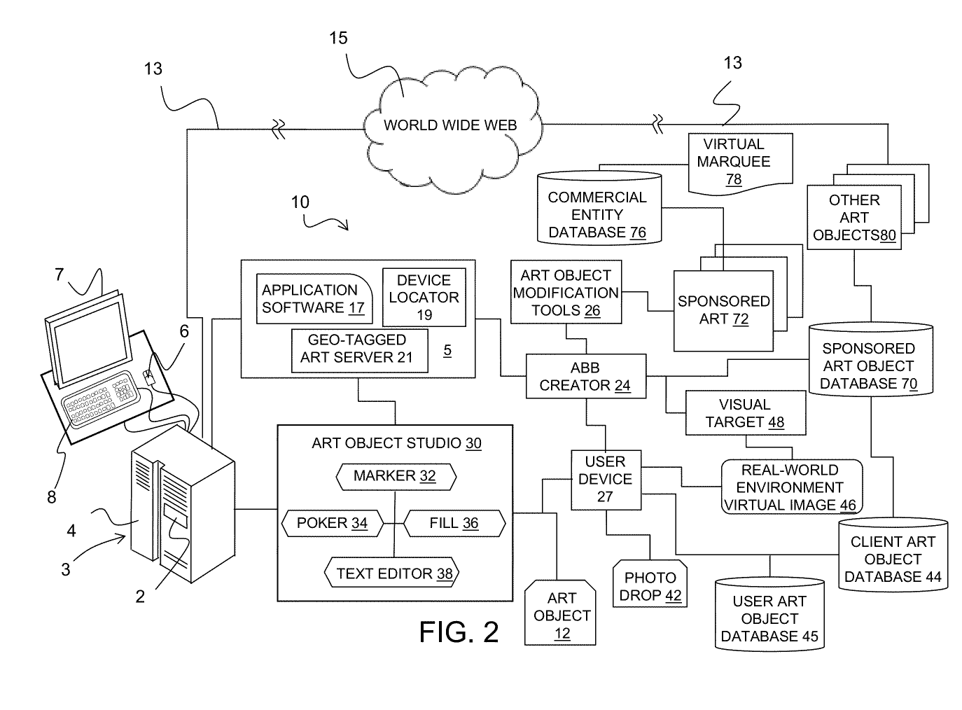

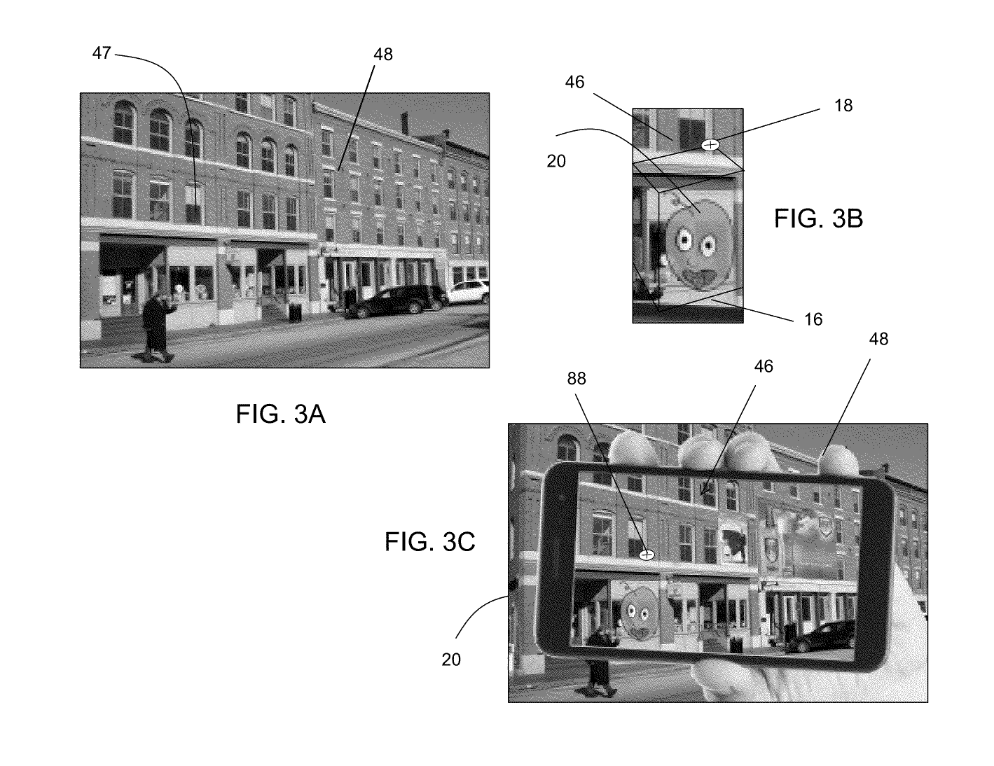

As shown in FIG. 2, the Art Object may be a User created 2D digital art work developed using tools within the Art Object Studio 30 of the Augmented Reality Software Application System Apparatus 10. These artistic creation tools 30 include; the Marker Tool 32 that allows the User to draw lines, curves, and shapes on a flat surface of the Virtual Target 46 and add them to an Art Object 12; the Poker Tool 34 that allows a User to resize, move, rotate, place, cut, copy, paste and perform other procedures that interact with an Art Object; the Fill Tool 36 provides for the User to change the color of a bounded area of a Real-World Environment Virtual Image 46 or Art Object 12; and the Text Editor 38 provides for a User to add and edit text associated with an Art Object 12. Alternatively, the User may upload an image of themselves or of another artistic work of art onto a Virtual Image 46 using the Photo Drop 42 that imports the image into the Art Object Studio 30 for further editing. The completed Art Objects 12 are then duplicated and transformed by the ABB Creator 24 that develops the Bounding Prism 16 and Handles 18 to create an Art Object Model 20. The Art Object Model 20 may then be linked to a Real-World Environment Virtual Image 46, as shown in FIG. 3B by selecting a Handle 18 on the Art Object Model 20 or Boundary Prism 16 and linking it to an Anchor Point 88 on the Virtual Image 46 that is geographically related to a Visual Target 48. The Anchor Point 88 on the Virtual Image 46 is then aligned with the Real-World Object 47 on the Visual Target 48, shown in FIG. 3A, to allow for the Art Object Model 20 to be displayed as if attached to the surface of a Real-World Object 47 to show the Art Object 12 in real-time on the Visual Target 48. The geographical location using GPS and physical sensors such as the orientation sensor on the mobile device assist in accurately aligning the Virtual Image 46 with the Visual Image 48.

Also shown in FIG. 2 is a first embodiment of the Augmented Reality Software Application System 10 implemented in computer hardware and computerized equipment. For example, the method can be performed using a system including one or more digital communications devices and/or one or more personal computers and data servers. Although the computer system 3 is shown for the purpose of illustrating a preferred embodiment, the present invention is not limited to the computer system 3 shown, but may be used with any electronic data processing system such as found in personal or other digital communications devices, cellular phones and other mobile devices, home computers, tablet computers, augmented reality glasses, or any other system for the processing of digital data. The computer system 3 includes a server computer 4 having a microprocessor-based unit 5 (also referred to herein as a processor) for receiving and processing software programs and for performing other processing functions. An output device 7 such as a visual display is electrically connected to the processor unit 5 for displaying User-related information associated with the software, e.g., by means of a graphical User interface. A keyboard 8 may also be connected to the processor unit 5 for permitting a User to input information to a software program. As an alternative to using the keyboard 8 for input, a mouse 6 may be used for moving a selector on the display 7 and graphical User interface, or alternatively a touch screen, hand gestures using 3D position sensor technology, or other input device may be provided for choosing an item and providing input to the processor 5. It is to be appreciated that the input is not limited to the known input apparatus and methods but includes input methods and devices which may yet be developed.

Memory and data storage, in any form, can be included and is illustrated as a hard-disk device such as computer readable storage medium 2, which can include software programs, and is connected to the microprocessor based unit 5 for providing a means of inputting the software programs and other information to the microprocessor based unit 5. Multiple types of memory can also be provided and data can be written to any suitable type of memory. Memory can be external and accessible using a wired or wireless connection, either directly or via a local or large area network, such as the Internet. Still further, the processor unit 5 may be programmed, as is well known in the art, for storing the software program internally. The output device 7 provides visually to the User transactional, interactive or variable data that has been Subject to transformations. The output device 7 can be a monitor, touch screen or other visual computer screen or graphical User interface (GUI), a printer or other output device that provides a visual or other representation of a final output from the processor unit 5. The output device 7 can also be an output device that provides the transactional data as a digital file. The processor unit 5 provides means for processing the transactional, interactive or variable data to produce readily discernible, informational and organized images and data on the intended output device or media. Those skilled in the art will recognize that the present invention is not limited to just these mentioned data processing functions.

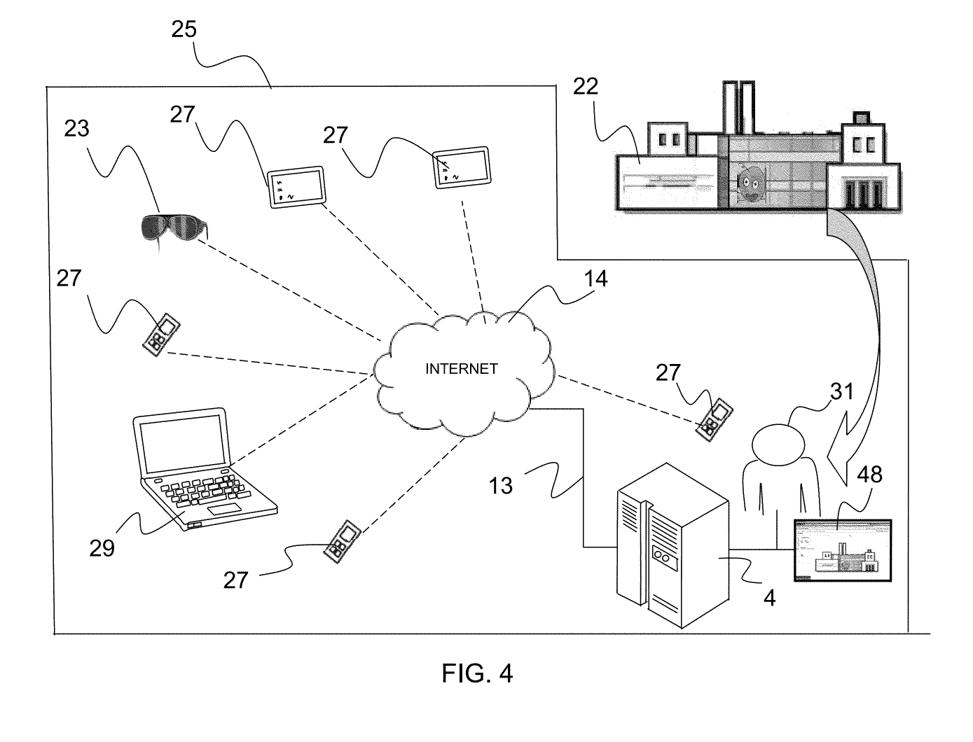

The server computer 4 can store a computer program product having a program stored in the computer readable storage medium 2, which may include, for example: magnetic storage media such as a magnetic disk or magnetic tape; optical storage media such as an optical disc, optical tape, or machine readable bar code; solid state electronic storage devices such as random access memory (RAM), read only memory (ROM) or flash memory data storage devices. The associated computer program and data server may be implemented through application software 17 on a SaaS (Software as a Service) or on demand computing service such as a Cloud or shared resource database through a web browser. A secure login with password may be provided to remotely access the software 17 through an intranet or internet connection 13. One or more of the devices to access the application software system 10 may be connected wirelessly, such as by a cellular link, Wi-Fi wireless, Bluetooth technology or other technology where the device is either directly connected or via a network. It is to be appreciated that such devices can be mobile devices (e.g., camera, PDA, iPod, iPad, tablet computer, augmented reality glasses, smartphone, or cell phone that can be used as a processing unit, a display unit, or a unit to give processing instructions), and as a service offered via the World Wide Web 15. The network 25 of the present invention as shown in FIG. 4 comprises a next-generation cellular network, capable of high data rates. Such systems include the enhanced Evolved Universal Terrestrial Radio Access (UTRA) or the Evolved Universal Terrestrial Radio Access Network (UTRAN) (also known as EUTRA and EUTRAN) within 3GPP, along with evolutions of communication systems within other technical specification generating organizations (such as ‘Phase 2’ within 3GPP2, and evolutions of IEEE 802.11, 802.16, 802.20, and 802.22). Devices comprise User Devices 27, such as augmented reality glasses 23, capable of real-world imaging and providing a User with the Real-World Environment Virtual Images 46 augmented with the Art Object Models 20 and the artistic creation tools 30 and modifiers 26 of the Augmented Reality Software Application System 10. Other devices may include Commercial Entity Devices 29 that subscribe to the Network 25 of Sponsored Art Object Models 72 to dynamically change Visual Targets 48 in real-time based on User Device 27 preferences, proximity and demographics. Operational control of the Geo-Tagged Art Server 21 is performed by one or more Administrators 31 that maintain privileges and access for the Commercial Entity Subscribers 29. The application software system 10 further includes a Device Locator 19 that uses latitude and longitude coordinates from the GPS location and other physical sensors of a device to determine proximity to Visual Targets 48 within the Network 25.

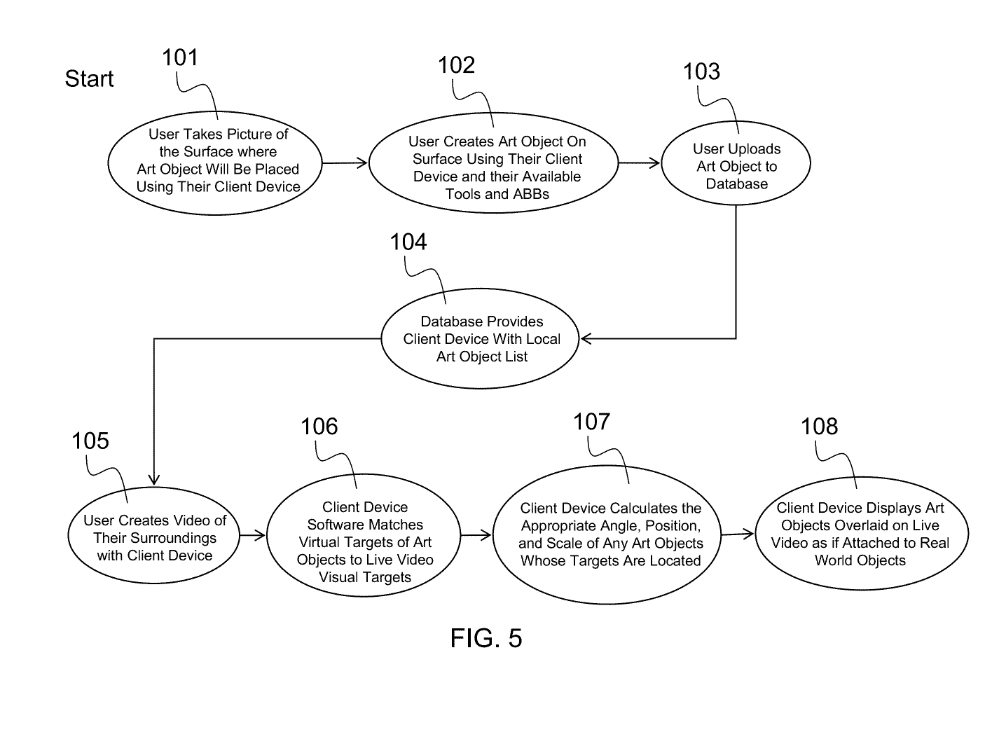

As shown in FIG. 5, the following procedural steps are performed to integrate an Art Object 12 with a live Visual Target 48. In a first step 101, the User takes a picture of the surface of an object within the Real-World Environment creating a Real-World Environment Virtual Image 46 where the Art Object 12 will be placed using their User Device 27. The Augmented Reality Software Application System Apparatus 10 records physical sensor data to, for example, set a pre-determined radius around the location of the Virtual Image 46 and records geographic data such as the GPS coordinates where the Virtual Image is taken to later associate the Virtual Image with a related live Visual Image. In step 102 the User creates the Art Object 12 on the surface of the Virtual Image 46 using their User Device 27 and the available artistic creation tools 30 and the Art Object 12 is duplicated into an ABB 14 and transformed into an Art Object Model 20; in step 103 the User uploads the Art Object Model 20 to the User or Client Art Object Database 44; in step 104, the Client Art Object Database 44 provides the User Device 27 with the Local Art Object List which is a list comprised of all the Art Objects 12 within a specific, pre-determined radius of the User Device 27 as determined by its internal sensors and/or network triangulation; the User in step 105 creates an image or video of their surroundings with the User Device 27; the Augmenter Reality Software System 10 integrates the Virtual Targets 46 of Art Object Models 20 to the image or live video Visual Targets 48 in step 106; at step 107, the User Device 27 calculates the appropriate angle, position, and scale of any Art Object Models 20 whose Visual Targets 48 are located within the proximity of the User Device 27; and at step 108, the User Device 27 displays the Art Object Models 20 overlaid on and integrated with an image or live video of the Visual Targets 48 as if attached to Real-World Objects 47.

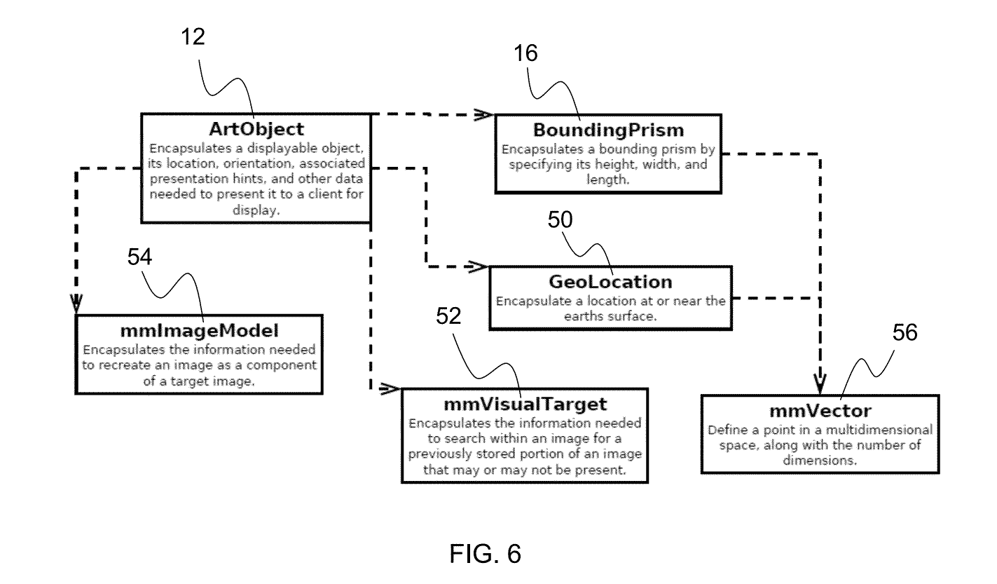

As shown in FIG. 6, in creating a Virtual Visual Target 46, the Art Object Model 20 developed from the User's Art Object 12 encapsulates a displayable object, its location, its orientation, compass direction, its associated presentation hints, and other data needed for the Model 20 to be presented on the User Device 27 for display or manipulation using the location of the Handles 18 on the Art Object 12 and Anchor Points 88 on the Virtual Target 46. At a high level this data is contained in the features and attributes of the Art Object Model 20 that include the Bounding Prism 16, the Geo Location 50, the mmVisualTarget 52, and mmImageModel Objects 54 that the Art Object 12 contains.

The Bounding Prism 16 encapsulates a rectangular boundary surrounding the Art Object 12 by specifying one vertex in an mmVector 56, and another mmVector 56 of the same dimension that contains the extent of the boundary. The Bounding Prism 16 may be displayed or not depending on the circumstances of the viewing of the Art Object 12. The mmVector 56 defines a point in a multidimensional space, relating to the number of preferred dimension features of the Art Object 12. This allows passing location, size, and any subfeature description information among the clients such as other User Devices 27 or Commercial Entity Subscribers 29 easily without regard to the type of descriptive data. The GeoLocation encapsulates a location of the Art Object 12 at or near the earth's surface. This consists of subsets of the following information, data supplied by the creating device's internal location sensors, such as GPS: latitude, longitude and elevation; data supplied by the creating device's orientation sensors: magnetic or solid state compass, a multiple axis gyroscope, accelerometers, and other sensors that may be incorporated to define the spatial characteristics of the Art Object 12.

The mmImage Model 54 encapsulates the information needed to recreate an image as a component of a Real-World Environment Virtual Image 46 and modify the image if allowed. This includes data such as, the default size and aspect ratio of the Virtual Image 46, the type of image; a list of graphical components, i.e. line segments, circles, rectangles, bitmaps, or ABBs, needed to reproduce the Virtual Image 46; a color or grayscale bitmap of the Virtual Image 46, a list of handles 18, points where the Virtual Image 46 may be manipulated; or a reference to a source for the Virtual Image 46, such as a URL for a web based image feed. The mmVisualTarget 52 encapsulates the information needed to search within the Real-World Environment Virtual image 46 for a previously stored portion of an image that may or may not be present. This includes, but is not limited to: a bitmap of the Virtual Image 46; a collection of points listing the location of prominent features in the Virtual Image 46, a range of transformation that may be applied to the image data during a search, and hints for selecting a search algorithm to properly define the Anchor Points 88 that are positioned on the live Visual Target 48. Additionally, each Art Object 12 also contains the following information the User Art Object Database 45; the identification of the creator, the Art Objects Rank in the entire Art Object collection, its date of creation, a history of modifications, and the description of how viewers may interact with the Art Object 12 and other information as required.

Within the Augmented Reality User Device Network 25, each Art Object 12 may be collected, bought, sold and ranked within an individual User or Client's Art Object database 44 or within a global Sponsored Art Object Database 70 that provides for Commercial Entities 29 to access User created Art Objects 12 and other available Art Objects 80. Within the network 25, each User has an associated rank with their User account associated with their Art Object database 44. This rank will be a number that is used to determine the Staying Power of their Art Objects 12 as well as allow the User to unlock additional Art Object Modification Tools 26. The User Rank is calculated by the number of Art Objects 12 that a User creates and the number of approvals their art gets. Users that wish to create Sponsored Art 72 involving Virtual Marquees 78 will be able to pay for a higher rank and access to extended features in the Art Object Modification Tools 26. Art Object Staying Power (Art Object Rank) will be determined by their associated User's rank, number of views, and number of likes minus number of dislikes.

Commercial Entities 29 who pay to be able to create Sponsored Art Objects 72 create Virtual Marquees 78 that may be accessible by said Commercial Entity 29 to display at the location that the Entity 29 specifies for the Sponsored Art Object 72. These Virtual Marquees 78 can display any information that the Commercial Entity 29 wishes and cannot be overwritten by other Users. The Virtual Marquees 78 may present advertisements, coupons, sales, discounts, games, surveys, interactive content or other information about the location or Commercial Entity 29. These Sponsored Art Objects 72 may further be stored within a Commercial Entity Database 76 for the Commercial Entity 29 to create their own Virtual Marquee 78 and modify and manipulate the Sponsored Art Objects 72. The Commercial Entity 29 may further post their Real-World Environment Virtual Images 46 of their location to allow User's to compete for the selection of their Art Objects 12 as the Sponsored User Art Objects 72 via a web based interface that presents the image of the building or location to User's within the Augmented Reality Network 25.

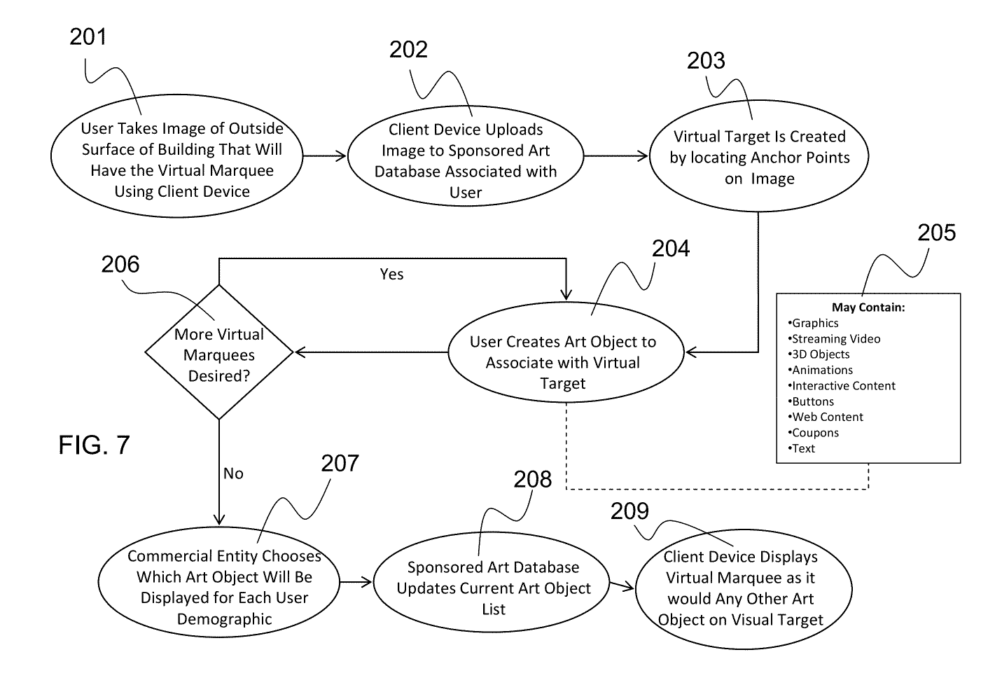

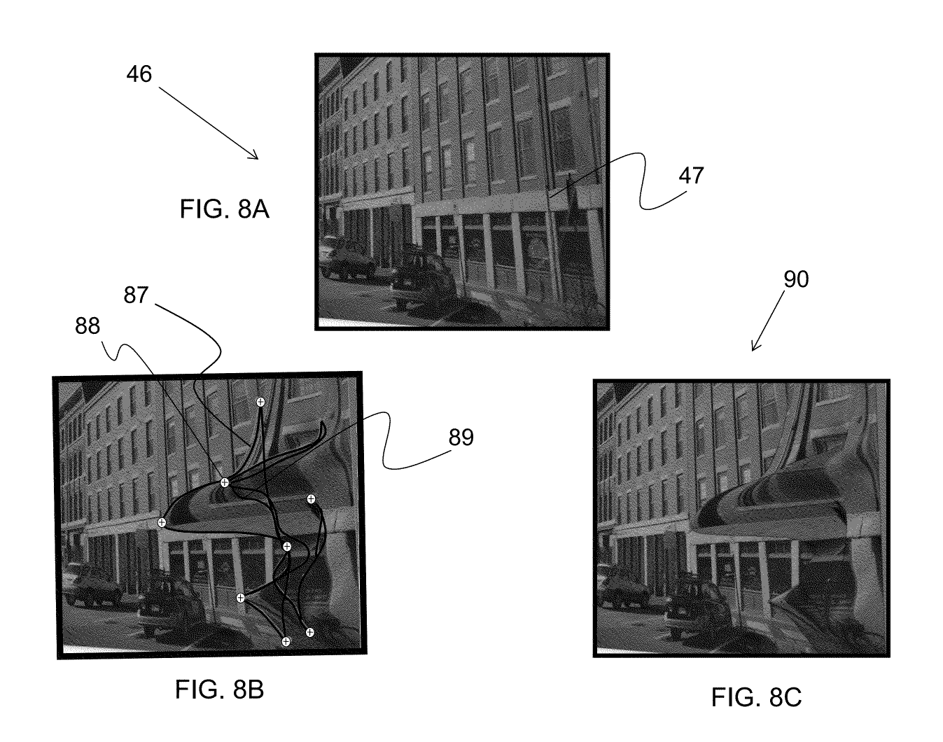

As shown in FIG. 7, the procedural steps for creating a Virtual Marquee 78 are described where in step 201 the User takes a Real-World Environment image of the outside surface of a building that will have the Virtual Marquee 78 using the Users Device 27 or the Commercial Entity's Device 29. In step 202, the Client's Device uploads the image to the Sponsored Art Object Database 70. Anchor Points 88 are located on the image to create a Virtual Target Image 46 in step 203 and a User then creates an Art Object 12 that is associated with the Virtual Target 46 at step 204. As shown at step 205, the Art Object 12 may contain, but is not limited to, Graphics, Streaming Video, 3D Objects, Animations, Interactive Content, Buttons, Web Content, Coupons, Games, and Text. The Commercial Entity 29 may determine if more Virtual Marquees 78 are desired to be displayed at the location at step 206 and may choose a particular Virtual Marquee 78 based on the demographics of the Users that frequent the location at step 207. The selected Virtual Marquee 78 is updated to Current Art Object List in the Sponsored Art Database 70 at step 208 and a User's Device displays the Virtual Marquee 78 as it would any other Art Object 12 at step 209. The Augmented Reality Software Application System 10 includes the Art Object Modification Tools 26 that provide for enhanced image manipulation tools to deform and distort an image. As shown in FIG. 8A, a Real-World Environment Virtual Image 46 that includes a Real-World Object 47 may be distorted by having a User draw in Warp Field Lines 87 that have Anchor Points 88 with points to drag within the image to extend and contort the image in different directions and dimensions as shown in the distorted Image 89 of FIG. 8B. The User may then save the artistically created modified augmented image 90 as shown in FIG. 8C.

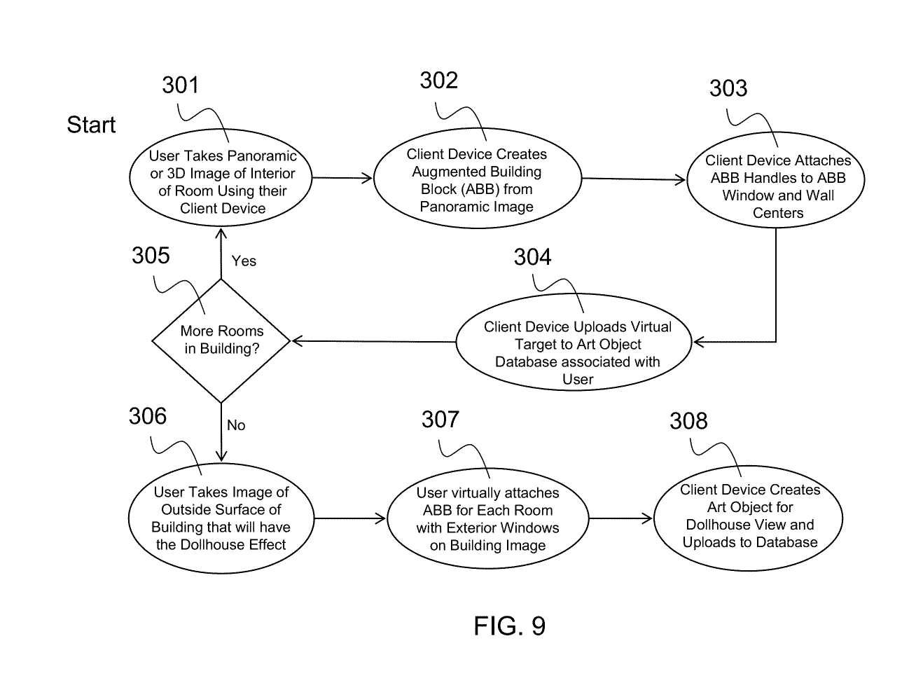

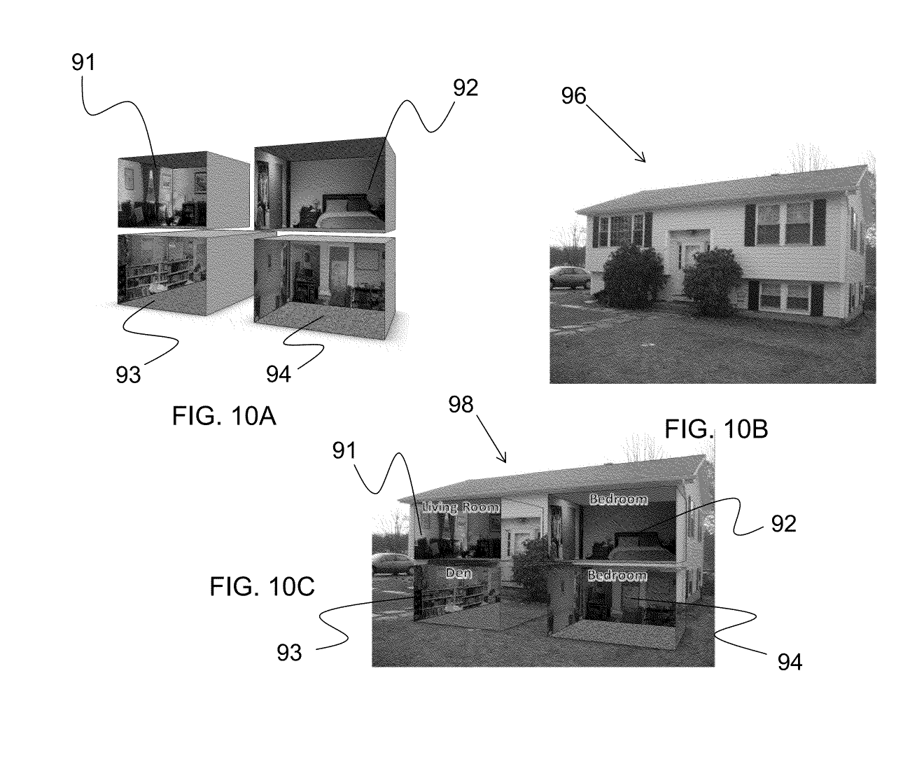

The Art Object Modification Tools 26 and features of the Augmented Reality Software Application System 10 may further provide for the User to create a Virtual Dollhouse 98 depicting an internal view of the Real-World Object 47. The procedural steps are shown in FIG. 9 where in step 301, the User takes a panoramic or 3D Image of an interior of a room using their Client Device. At step 302, the Client Device creates a unique Augmented Building Block (ABB) 14 from the panoramic image. At step 303, the ABB Creator 24 creates Handles 18 that are linked at the center of each wall and window of interior image creating a Room Image Model 91. The Client Device uploads the Room Image model 91 to the Clients Art Object Database 44 at step 304. More rooms may be added and transformed to ABBs 14 at step 305. The User takes an image 96 or video of the outside of the building that will have the Dollhouse Effect 98 at step 306. The User then virtually attaches the Handles 18 of the ABB Models for Each Room 91-94 with Anchor Points 88 at the exterior windows of the Building Image 96 at step 307. The Client Device creates the Dollhouse Virtual Target 98 at step 308 to be viewed and uploaded to the Database 44. A Dollhouse Visual Target may be displayed on a smartphone or mobile computer system to show a live video of the exterior of a building wall with an overlay of the display of the contents of each room that is adjacent to that exterior wall on the inside of the building. As shown in FIGS. 10A-10C, the Dollhouse Effect shows the building with the exterior wall removed and the contents of each room accurately represented showing the interior walls and the rooms arranged in their proper orientation with respect to the floor plan. In this example, a building is presented showing the interior rooms of a home, however any interior such as a virtual depiction of the internal organs of a human body may be displayed by transforming the internal Virtual Image to an ABB 14 with any number of Handles 18 to structurally orient and accurately scale the internal virtual image and attach the Handles 18 of the image to the Anchor Points 88 of the external image. Other applications such as displaying the interior of an automobile in a live action video are within the scope of the present invention by creating one or more ABBs 14 having Handles 18 and Virtual Images 46 having Anchor Points 88 to provide the accurate orientation and linking of each Art Object Model 20 to any live Visual Target 48.

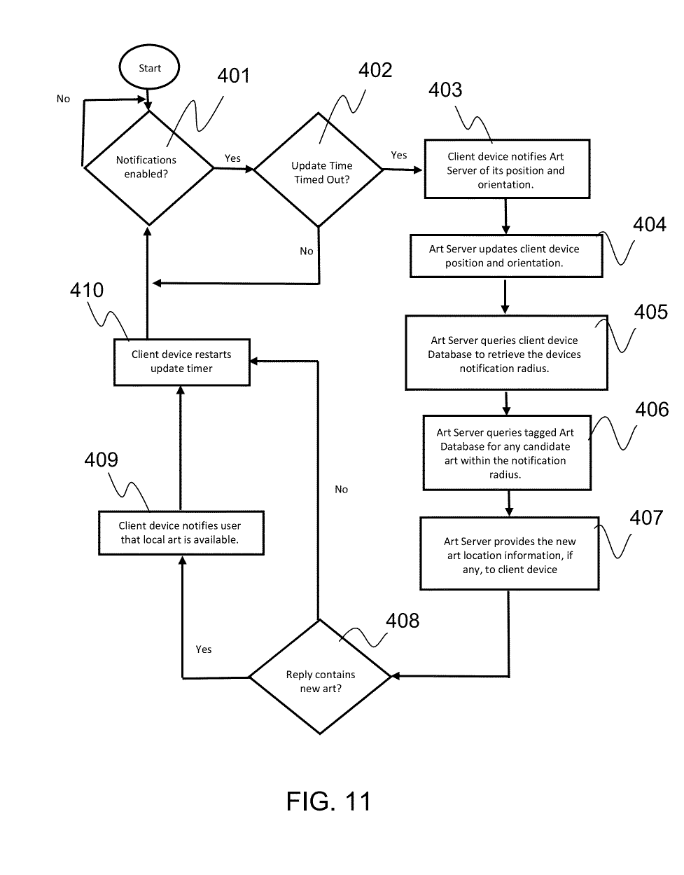

As shown in the flow chart of FIG. 11, the depiction of the Dollhouse Effect 98, a Virtual Marquee 78 or any other Visual Target 48 may be determined by the proximity of the Client Device to the location of the Visual Target 48. A Client Device 27 or 29 may have Notifications Enabled 410 and the Device Locator 19 may pole a region periodically to determine if these Notifications are updated 402. If Notifications are accepted the Client Device notifies the Art Server 21 of its position and orientation 403. The Art Server 21 updates the position and orientation of the Client Device 404 and queries the Client Device Database to retrieve the device notification radius 405. The Art Server 21 queries the Sponsored or Tagged Art Database 70 for any candidate art that includes Other User's Art 80, Sponsored User's Art 72 and Virtual Marquees 78 from a Commercial Entity 29 at 406. The Art Server 21 provides the new Art location information, if any, to the Client Device 407 and requests a reply 408. The Client Device notifies the User of available local art 410 and the User accepts or denies the request and the Update Timer is reset at 402. In this manner a User may choose to view the available local art display. The art display may further be targeted to a User device based on the demographics of the User where as an example an 18 to 25 year old may be presented with a different Visual Target 48 than a User that is 25 to 40.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

What is claimed is:

1. An augmented reality software system apparatus for the integration of an art object with a real-world environment image, comprising:
application software stored in memory of a mobile computer system, the mobile computer system having a camera, the application software comprising;
an art object studio;
an augmented building block creator;
an art object database; and
wherein a picture of an object in a real-world environment is taken and saved to memory of the computer system as a virtual target;
a digital art object is created in the art object studio and duplicated; and
the art object is then transformed into an art object model using the augmented building block creator by adding a bounding prism and at least one handle located on one of at least the art object and bounding prism;
the at least one handle is attached to at least one anchor point on the virtual target and the art object model with the virtual target is saved to the art object database,
a live picture of a related real-world environment visual target image is taken using the camera of the mobile computer system; and
using the application software the virtual target is aligned to the visual target using the at least one anchor point to display the art object in real-time on the visual target.

2. The augmented reality software system apparatus for the integration of an art object with a real-world environment image of claim 1 wherein the visual target is a live video.

3. The augmented reality software system apparatus for the integration of an art object with a real-world environment image of claim 1 wherein the placement and adjustment of the handles modifies one of at least the shape, scale and orientation of the art object model.

4. The augmented reality software system apparatus for the integration of an art object with a real-world environment image of claim 3 further comprising a plurality of augmented building blocks each having the same art object and each having handles at different locations on a feature of the art object or the bounding prism; and wherein the augmented building blocks are stackable.

5. The augmented reality software system apparatus for the integration of an art object with a real-world environment image of claim 1 further comprising art modification tools that provide for warp field lines to be drawn on the virtual target.

6. The augmented reality software system apparatus for the integration of an art object with a real-world environment image of claim 5 further comprising anchor points positioned along the warp field lines on the virtual target to manipulate objects within the virtual target to perform one of at least a modification, a deformation, a distortion, and change of shape of the visual target when integrated with the virtual target.

7. The augmented reality software system apparatus for the integration of an art object with a real-world environment image of claim 1 further comprising:
a device locator that records the geographic location around at least one visual target with the device locator pre-setting a radius around the geographic location and providing notifications of available art objects stored within one of at least the user art object database; a client art object database; a commercial entity database, a sponsored art object database, and the available art objects being accepted by a user for integration with real-world environment visual targets within the geographic location.

8. The augmented reality software system apparatus for the integration of an art object with a real-world environment image of claim 7 wherein the available arts objects are displayed on the visual target based on a ranking.

9. The augmented reality software system apparatus for the integration of an art object with a real-world environment image of claim 1 wherein the visual target is a building and the art object model is an interior display of a room within the building creating a virtual dollhouse using the handles of the augmented building block and anchor points on the virtual target to align the interior room art object model within the walls of the building as displayed on the visual target.

10. The augmented reality software system apparatus for the integration of an art object with a real-world environment image of claim 1 wherein the art object is one of at least an animated image, a video, an operable button, web content, a survey, a coupon, a gift and a game.

11. A method for the integration of an art object with a real-world environment image using an augmented reality software system, comprising the steps of:
installing application software in the memory of a mobile computer system, the mobile computer system having a camera;
taking a picture from a real-world environment using the camera of the mobile computer system;
saving the picture as a virtual target;
creating a digital art object;
duplicating the art object;
transforming the duplicated art object using an augmented building block creator into an art object model by adding a bounding prism and at least one handle on one of at least a feature of the art object and the bounding prism;
attaching at least one handle of the art object model to at least one anchor point located on the virtual target;
taking a live picture from a real-world environment using a camera as part of the mobile computer system;
recording geographic and physical sensor data related to the real-world environment live picture to form a visual target;
aligning at least one anchor point of the virtual target with an object located on the visual target to display an integrated live real-world image having the art object.

12. The method for the integration of an art object with a real-world environment image using an augmented reality software system of claim 11, further comprising the steps of:
taking a live video from a real-world environment using the camera of the mobile computer system;
recording geographic and physical sensor data related to the real-world environment live video to form a visual target;
aligning at least one anchor point of the virtual target with an object located on the visual target to display an integrated live real-world video having the art object.

13. The method for the integration of an art object with a real-world environment image using the augmented reality software system of claim 11, further comprising the step of:
performing one of at least modifying the art object model using the handles to change one of at least the shape of the art object, the scaling of the art object, and the orientation of the art object.

14. The method for the integration of an art object with a real-world environment image using the augmented reality software system of claim 13, further comprising the steps of creating a plurality of augmented building blocks each having the same art object and each having handles at different locations on the art object or bounding prism; and stacking the augmented building blocks.

15. The method for the integration of an art object with a real-world environment image using the augmented reality software system of claim 11, further comprising the steps of:
drawing warp field lines on the virtual target using art modification tools of the application software;
positioning anchor points along the warp field lines on the virtual target to manipulate the virtual target to perform one of at least a modification, a deformation, a distortion, and change of shape when integrating the virtual target with the visual target.

16. The method for the integration of an art object with a real-world environment image using the augmented reality software system of claim 11, further comprising the steps of:
recording the geographic location of at least one visual target;
presetting a radius around the geographic location; and
providing notifications of available art objects stored within one of at least a user art object database; a client art object database; a commercial entity database, a sponsored art object database,
accepting from the selection of available art objects an art object for display and integration with the real-world environment visual target within the geographic location.

17. The method for the integration of an art object with a real-world environment image using the augmented reality software system of claim 17, further comprising the steps of ranking the available art objects for display and displaying the available art objects integrated with the visual target based on the ranking.

18. The method for the integration of an art object with a real-world environment image using the augmented reality software system of claim 17, further comprising the steps of taking a picture of a building as the virtual target;
creating an art object that is an interior display of a room within the building of the virtual target;
creating a virtual dollhouse by attaching the handles of the augmented building block of the art object model to at least one anchor point of the virtual target to align the interior room art object model within the walls of a related visual target that is a live video of the building.

19. The method for the integration of an art object with a real-world environment image using the augmented reality software system of claim 11, further comprising the steps of creating the art object as one of at least an animated image, a video, an operable button, web content, a survey, a coupon, a gift and a game.

20. The method for the integration of an art object with a real-world environment image using the augmented reality software system of claim 11, further comprising the step of creating a virtual sign post at a geographic location, the sign post having handles for the attachment of an art object.
